(19) United States
(12) Patent Application Publication
(10) Pub. No.: US 2010/0140021 A1
(43) Pub. Date: Jun. 10, 2010

(54) FARM IMPLEMENT

(76) Inventor: Michael Gillotti, Sebastopol, CA (US)

Correspondence Address: Bay Area Technolgy Law Group PC, 500 Sansome Street, Suite 404, San Francisco, CA, 94111, US

(21) Appl. No.: 12/328,235

(22) Filed: Dec. 4, 2008

(51) Int. Cl. B66F 9/12; A01C 11/00

(52) U.S. Cl. 187/237; 111/100

(57) ABSTRACT

A device for increasing the spacing of pots in an open area configured for attachment to a vertically actuatable fork lift supported by a moving vehicle such as a tractor. The device includes a horizontally extending member, plurality of forks, each fork including parallel rails, a first end of the parallel rails being appended to a continuous drive located within the horizontally extending member and a reversible motor geared to the continuous drive such that when the reversible motor is actuated in the first direction, the forks are caused to separate from one another and when the reversible motor is actuated in the second direction, the forks are caused to move closer to one another. A series of longitudinally extending members are provided extending from the horizontal member along each of the parallel rails, each longitudinally extending member supporting a plurality of flippers, each flipper being spaced apart from the adjacent flipper on each of the longitudinally extending members such that when the longitudinally extending members are in a first orientation, the flippers extend horizontally from the parallel rails and when the rods are in a second orientation, the flippers extend vertically from the parallel rails. The flippers assume horizontal or vertical orientations depending upon whether pots located within the forks are to be lifted or are to remain in place.

### TECHNICAL FIELD

The present invention is directed to a device intended to be supported by and connected to a forklift and which is capable of increasing the spacing of an array of pots to enhance plant growth. Typically, pots are placed on pallets and delivered to open areas of a farm or nursery. After plant delivery, the pots must be separated which, up to now, has been a laborious task requiring the pot-by-pot manual manipulation.

### BACKGROUND OF THE INVENTION

As previously noted, there is a routine generally followed in the delivery of potted plants to a commercial installation such as a farm or nursery requiring post delivery manipulation to ensure appropriate plant growth. Specifically, plants are received by such an installation in pots or are potted on site. To maximize efficient plant delivery, pots are nested in tightly packed arrays and are generally supported on pallets. These pallets are moved to an appropriate area of the commercial facility, that is, an area where it is anticipated that the pots will remain during growth. However, plants will not adequately grow if the pots are not separated and spaced from one another soon after delivery.

It is the common practice of commercial facilities to engage the services of day laborers who proceed to the palletized, tightly nested pots whereupon the pots are moved to increase their spacing. This is a time consuming task and one which is quite labor intensive as each pot must be physically lifted and moved to an appropriate position to encourage appropriate plant growth. Further, because this task is performed manually, it is oftentimes difficult to ensure that spacing from pot to pot is ideal or that uniform and consistent rows of pots are established. Results oftentimes are mixed resulting in poor plant growth and haphazard spacing.

It is thus an object of the present invention to provide a device capable of engaging rows of tightly nested pots and for increasing pot spacing without need for the services of manual laborers.

It is a further object of the present invention to provide a device capable of attachment to a traditional forklift or a tractor outfitted with a forklift which can be easily employed by anyone with even modest skill in forklift operation.

It is yet a further object of the present invention to provide a device which can employ as a preferred embodiment the hydraulic system of a forklift or tractor for actuation of its component parts, without the necessity of an independent power source thus allowing for a more efficient and cost effective manner for spacing pots more efficiently and reliably than is heretofore been possible.

These and further objects will be more readily apparent when considering the following disclosure and appended claims.

### SUMMARY OF THE INVENTION

The present invention is directed to a device for increasing the spacing of pots in an open area, said device configured for attachment to a vertically actuatable forklift supported by a moving vehicle such as a tractor, said device comprising a horizontally extending member, a plurality of forks, each fork comprising a pair of parallel rails, a first end of said parallel rails being appended to a continuous drive such as a chain drive located within said horizontally extending member, a reversible motor geared to said continuous drive such that when said reversible motor is actuated in a first direction, said forks are caused to separate from one another and when said reversible motor is actuated in a second direction, said forks are caused to move closer to one another. A series of longitudinally extending members, such as rods, are provided protruding from said horizontally extending member along each of said parallel rails, each longitudinally extending member supporting a plurality of flippers, each flipper spaced apart from an adjacent flipper on each said of said members such that when said members are in a first orientation, said flippers extend substantially horizontally from said parallel rails and when said members are in a second orientation, said flippers extend substantially vertically from said parallel rails. Means are provided to move said longitudinally extending members between said first and second orientations noting that said members are biased to cause said flippers to assume said first (horizontal) orientation.

The invention further is directed to a method of increasing spacing of pots arranged in an array of columns comprising operating a vehicle having appended thereto the device described above, aligning said pots with the forks of said device such that said columns of pots are positioned between the pairs of parallel rails, moving said device to capture said pots between said parallel rails, actuating a reversible motor and moving a continuous drive to separate said forks from one another. Thereupon, longitudinally extending members travelling down said rails are rotated from their first to their second orientations followed by elevating said device a sufficient height such that a first series of pots between flippers remain on the ground or pallet and a second series not between flippers are elevated above said first series. The vehicle is then moved away from the array to displace said second series of pots from said first series.

### BRIEF DESCRIPTION OF THE FIGURES

FIG. 1 is a perspective view of the present invention as it is intended to be installed on a conventional forklift.

FIG. 2 is a top perspective view of a portion of the present invention as it engages pots for commercial use.

FIG. 3 is a view of the present invention in use as pots are engaged therein.

FIG. 4 is an elevational perspective view of the arrangement shown in FIG. 3 as various rows of pots are shown being separated from one another.

FIG. 5 is a side elevational perspective view of the present invention showing how pots within rows are separated from one another.

FIG. 6 is a side elevational perspective view continuing the separation process as depicted in FIGS. 4 and 5.

FIG. 7 is a schematic illustration of the fork spacing arrangement for use in the present invention.

FIG. 8 is a schematic view showing a device for orienting the various flippers to create selective pot elevations in practicing the present invention.

FIGS. 9a and 9b are partial perspective views illustrating the detail of the flippers and supporting rods as shown in FIG. 8.

FIG. 10 is a perspective view of diverter members for use herein.

### DETAILED DESCRIPTION OF THE INVENTION

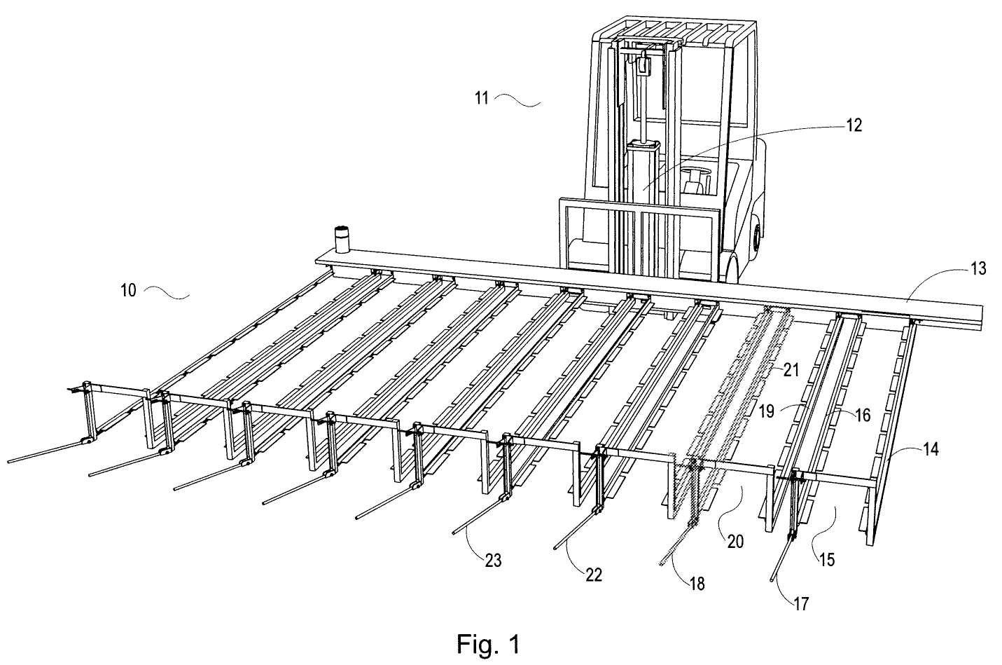

Turning first to FIG. 1, forklift 11 is shown supporting device 10 of the present invention. In doing so, horizontally extending member 13 is affixed to a frame which in turn is capable of being moved vertically through the use of hydraulic member 12. As will be more apparent when considering the disclosure which follows, an important feature of this invention is to not only separate pots in a horizontal plane but also to selectively lift alternating pots in a single row or column, thus necessitating the need to affix device 10 to vehicle 11 having the capability of moving device 10 vertically, a capability of any commonly available forklift.

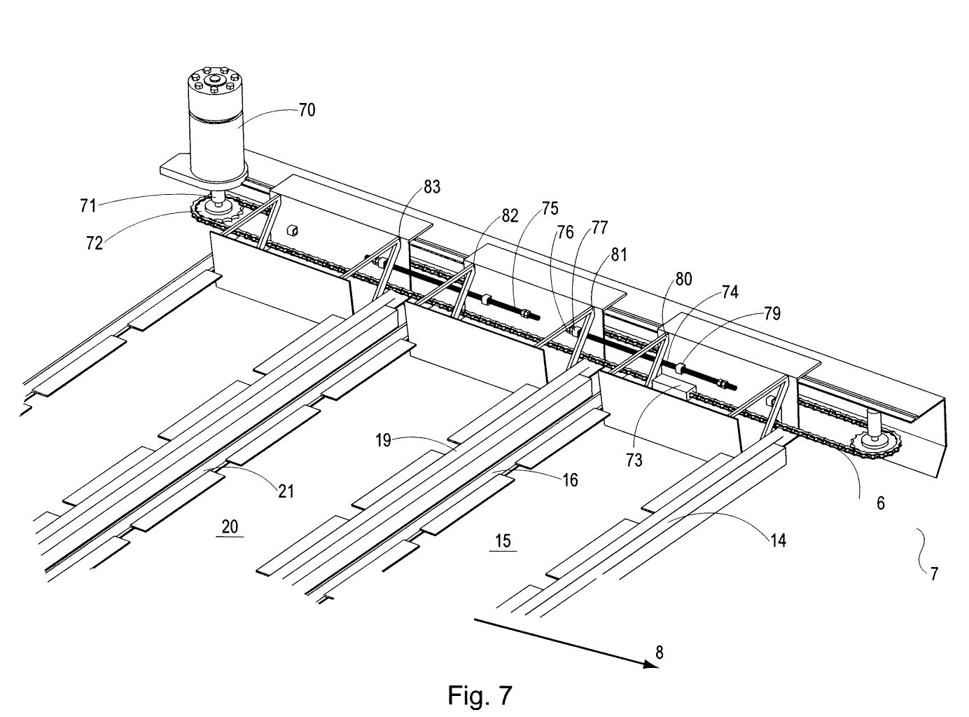

Turning once again to FIG. 1, it is noted that device 10 not only includes horizontally extending member 13 but also a plurality of forks 15, 20, etc., each fork comprising a pair of parallel rails 14-16, 19-21, etc., noting that first ends of the parallel rails are appended to a continuous drive such as a chain drive located within horizontally extending member 13 (FIG. 7) to enable forks 15, 20, etc., to separate from one another for reasons which will be discussed below.

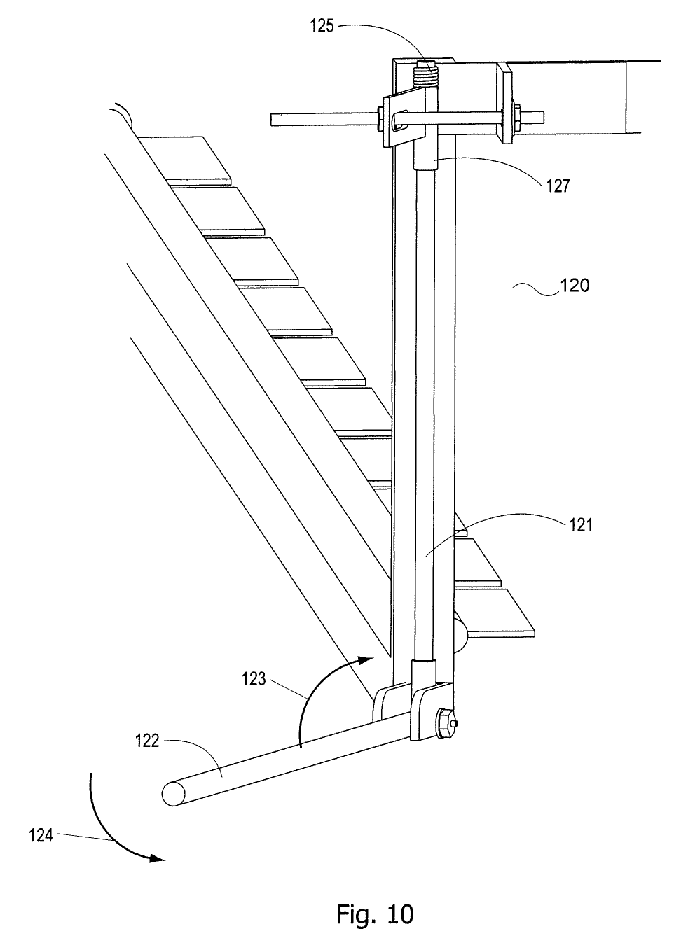

Each rail 14-16, 19-21, etc., supports diverters such as rods 17, 18, 22, 23, etc., the details of which are illustrated in FIG. 10.

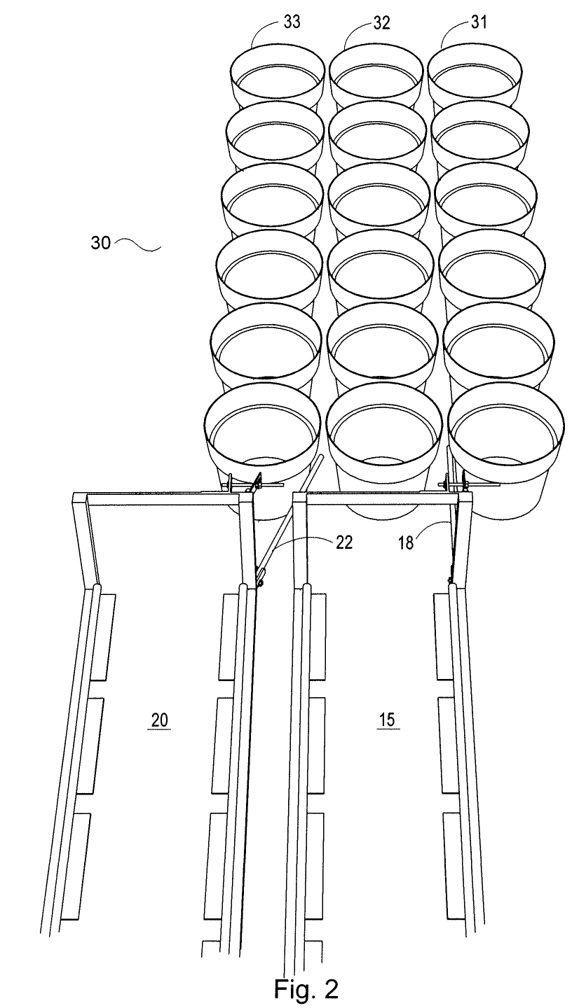

Reference is now made to FIGS. 2-6 describing the method of operating the present invention to space pots as required to stimulate plant growth.

Turning first to FIG. 2, it is noted that pot array 30 is arranged in columns 31, 32 and 33 although any number of columns could be separated by device 10.

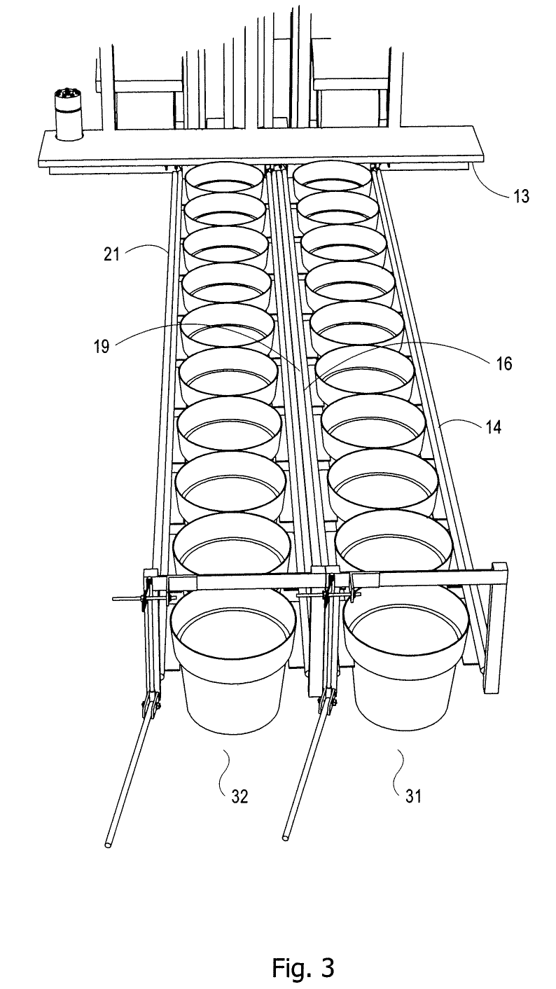

As a first step in the employment of the present invention, diverters 18 and 22 are caused to enter spacing between columns of pots 31, 32 and 33. As vehicle 11 moves in the direction of array 30, these pots are urged by the diverters to enter forks 15, 20, etc., assuming an arrangement as depicted in FIG. 3.

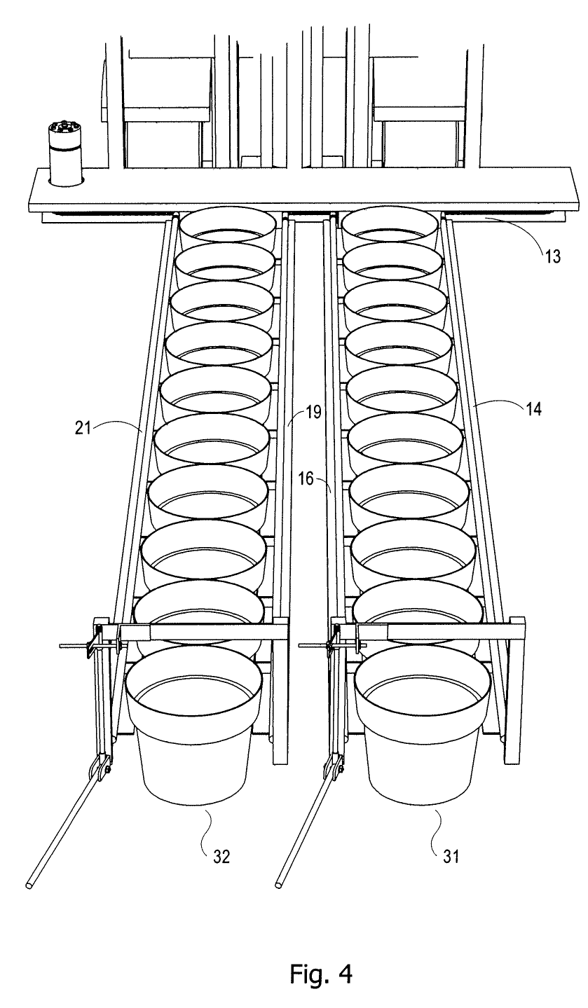

The next step of the operation can be readily appreciated in comparing FIGS. 3 and 4. Once the columns of pots 31, 32, 33, etc., are captured by the receiving forks, a reversible motor, such as a hydraulic or electric motor, is actuated causing the forks to separate from one another. Thus, column 32 is separated from column 31 once fork 15 is separated from fork 20. Rails 14-16 and 19-20 engage diametrically opposing positions of the various pots to ensure that their horizontal movement is carried out without incident as the pot columns transition from their FIG. 3 to their FIG. 4 orientations.

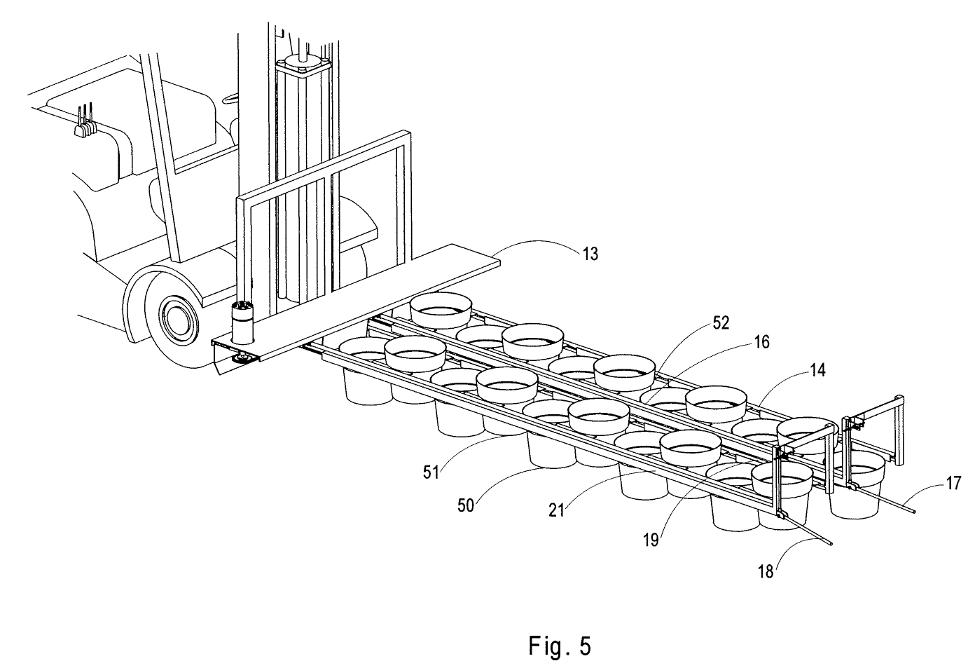

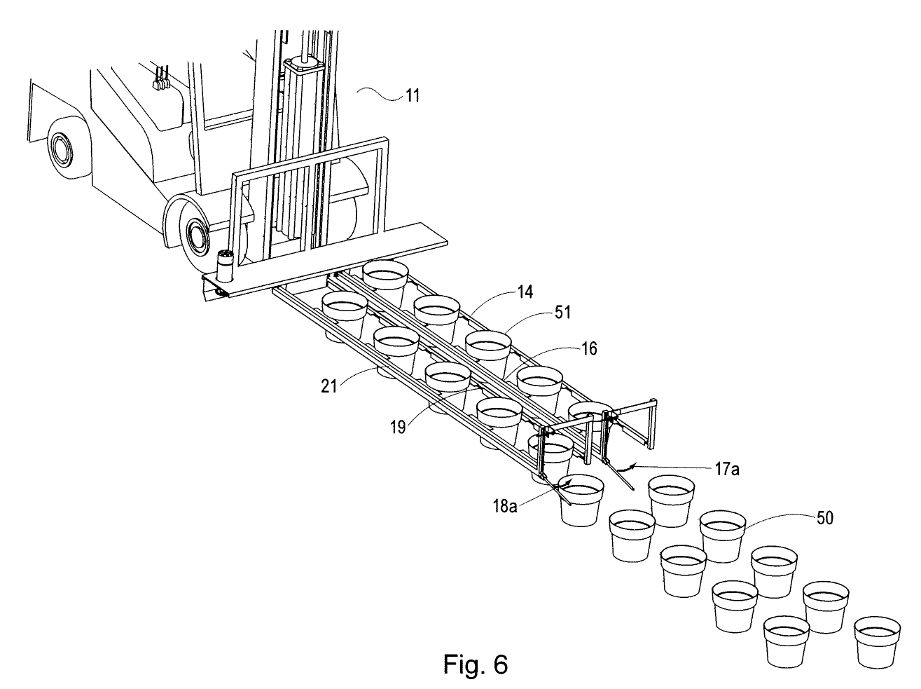

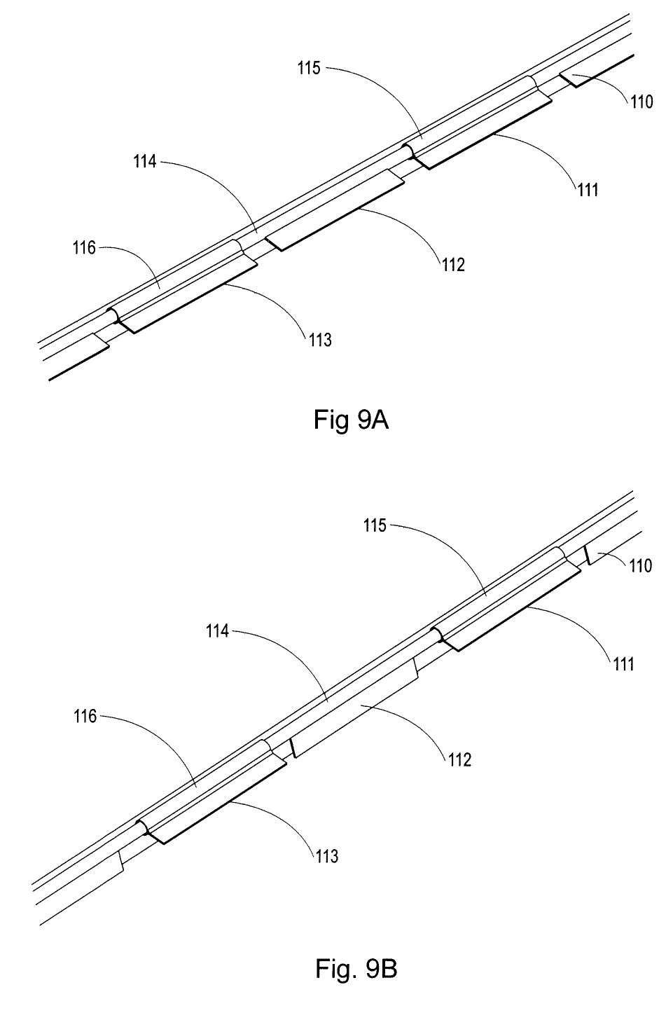

Further separation, that is, the separation of various pots within columns is carried out in a manner depicted in FIG. 5. Specifically, as previously noted, adjacent pots 50 and 51 initially reside on a common plane, either on the ground, on trailers or on pallets. Upon moving the flippers (110, 112 of FIGS. 9A, 9B) from their biased horizontal orientations to vertical orientations, pots 50 are caused to remain in place as the forks are vertically raised through actuation of hydraulic means 12 of vehicle 11. As the forks are raised, horizontally extending plates (111, 113 of FIGS. 9A, 9B) catch each pot at its lip 52 causing pots 51 to rise with the forks. In following through with this procedure, the forks are raised vertically to the extent that pots 51 can be moved over pots 50 as vehicle 11 moves away from previously established array 30. In this regard, reference is made to FIG. 6.

In transitioning from FIG. 5 to FIG. 6, it is noted that pots 50 reside in place while pots 51 remain between parallel rails 14-16, 19-21 and are elevated as the forks are vertically raised. Once the forks are raised to a sufficient height such that the bottoms of pots 51 are above the tops of pots 50, vehicle 11 is then caused to move away from the array, taking with it, the pots remaining within their respective forks. This is shown in FIG. 6. Once vehicle 11 has travelled a sufficient distance to space pots 51 from pots 50, the forks can be lowered whereupon pots 51 are returned to ground level as the forks continue to move away from the array thus disengaging entirely from the pots now suitably spaced.

It should further be noted that diverters 17, 18, 22, etc., are provided with certain characteristics best visualized in considering FIGS. 1, 2, 6 and 10. It is firstly noted that the diverters emanate from their various forks at the extension of the rails at varying angles to facilitate the urging of pot columns within their respective forks between suitable parallel rails. This aspect of the invention can best be appreciated in viewing FIG. 1. It is next noted that the diverters, being spring biased and capable of being urged against such bias can be reoriented as the forks withdraw from the column of pots. This facilitates withdrawal and prevents inadvertent pot displacement. As such, as vehicle 11 moves away from the array in transitioning from its FIG. 5 to FIG. 6 position, diverters, for example, rods 17 and 18 are urged in the direction of arrows 17a and 18a by the pots residing at ground level.

As a means of establishing appropriate diverter functionality, reference is made to FIG. 10. As in this example of a preferred embodiment of the present invention, diverter assembly 120 includes vertically extending rod 121 channeled within tubular collars 127. Rod 121 is biased through the use of coil spring 125 enabling diverter 122 to be urged in the direction of arrow 124 when being withdrawn from a column of pots. To further enhance the functionality of the present invention, diverter 122 can pivot in the direction of arrow 123 to enable the ends of each fork to abut against a barrier or array of objects without the diverters rod inadvertently creating an impediment.

As previously noted, as a first step in the pot separation process, the various forks 15, 20, etc., once receiving columns of pots, are then caused to separate from adjacent forks as visualized in comparing FIGS. 3 and 4. In carrying out this function, reference is made to FIG. 7.

In turning to FIG. 7, reversible motor 70 is affixed to vehicle 11 and is ideally an hydraulic motor that operates employing the hydraulics of the vehicle controlled by handles, levers or other suitable means located proximate the vehicle's operator. Reversible motor 70 is provided with shaft 71 and tooth gear 72 which engages a continuous drive, depicted as its preferred embodiment as chain 6. Chain 6 is affixed to fork 15 by mounting block 73. As reversible motor 70 turns tooth gear 72 and moves chain 6 in a first direction, fork 15 moves in a first direction towards extremity 7. In doing so, a linkage arm 74, appended and bridging vertically extending members 80 and 81, causes fork 20 to move in a direction of extremity 7. Linkage 74 can be in the form of a linking arm as depicted in FIG. 7, or can be a cable or any other bridging element of selectable or fixed length. As to the preferred embodiment of FIG. 7, fork 20 moves toward extremity 7 once stop 77 supported by linkage 74 abuts vertically extending member 81. In its preferred embodiment, the, the spacing between forks 15, 20, etc., is adjustable by adjusting threaded nut 76 upon linkage 74 as shown. Similarly, fork 20 will then urge its adjacent fork also in the direction of extremity 7 as linkage 75 bridging vertically extending members 82 and 83 moves. Abutting stop 79 acts upon vertically extending member 80, also adjustable by providing a threaded connection. Movement of the various forks in the direction of arrow 8 continues until fork 15 reaches extremity 7 of horizontally extending member 13.

Once the present device has been deployed to cause the pots within an array to suitably separate, reversible motor 70 can be caused to reverse its direction of rotation whereby each of forks 15, 20, etc., nest to its original compacted orientation as extreme most fork 15 abuts fork 20, etc. The device at that point would be in a position to be moved or stored or, in the alternative, to address a new compacted array of pots requiring separation.

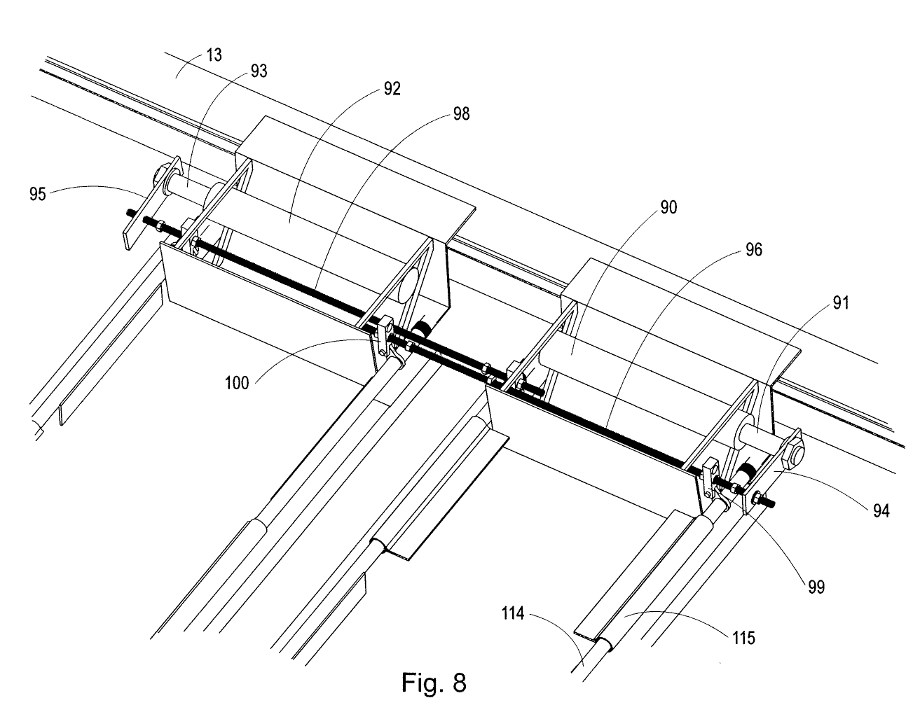

As is further apparent from the above discussion, once the various forks have been separated, alternating pots within any one column remain at ground level while adjacent pots are vertically raised. This is accomplished in a manner illustrated by reference to FIGS. 8, 9a and 9b.

Turning first to FIG. 8, it is noted that cylinders 90 and 92, affixed to horizontally extending member 13, possess retractable shafts 91 and 93. Linkages 94 and 95 emanate from each shaft and are affixed to horizontally extending arms 96 and 98, respectively. Arm assemblies 99 and 100 bridge their respective horizontally extending members 96 and 98 such that as shafts 91 and 93 extend and retract, longitudinally extending members, shown as rods 114 (FIGS. 9A, 9B) rotate within tubular sleeves 115, 116, etc., within their respective rails 14-16, 19-21, etc. Alternatively, longitudinally extending members 114 could be rotated by chains or cables and the like in which shafts 91 and 93 urge rotation against a spring bias. It should be apparent to anyone skilled in this art that various alternative means could be employed for this purpose without departing from the present invention.

In returning to the preferred embodiment of FIG. 8, members 114 can be biased by a suitable coil spring (not shown) or biased by the at-rest orientation of shafts 91-93 such that flippers 110, 112, etc, normally assume a horizontal orientation as shown in FIG. 9A. Flippers 110, 112, etc., are welded or otherwise permanently affixed to members 114 such that rotation of members 114 by urging of linkages on arm assemblies 99 and 100 can caused flippers 110, 112, etc., to move from their initial horizontal orientations (FIG. 9A) to vertical orientations (FIG. 9B). Thus, pots residing upon the ground or on pallets between opposing flippers on parallel extending rails of various forks would remain at ground level once the forks are vertically raised as the flippers which would otherwise catch on rims 52 and support them would no longer do so in assuming the vertical flipper orientation shown in FIG. 9B. However, pots located between opposing substantially horizontally extending plates 111, 113, etc., which are welded or otherwise permanently affixed to tubular sleeves 115, 116, etc., will vertically rise as plates 111, 113, etc. catch upon rims 52 as depicted in FIG. 5.

While a particular embodiment has been chosen to illustrate the invention, it will be understood by those skilled in the art that various changes and modifications can be made therein without departing from the scope of the invention as defined in the appended claims.

What is claimed is:

1. A device for increasing the spacing of pots in an open area, said device configured for attachment to a vertically actuatable forklift supported by a moving vehicle, said device comprising a horizontally extending member, a plurality of forks, each fork comprising a pair of parallel rails, a first end of said parallel rails being appended to a continuous drive located within said horizontally extending member, a reversible motor geared to said continuous drive such that when said reversible motor is actuated in a first direction, said forks are caused to separate from one another and when said reversible motor is actuated in a second direction, said forks are caused to move closer to one another, a series of longitudinally extending members extending from said horizontally extending member along each of said parallel rails, each longitudinally extending member supporting a plurality of flippers, each flipper spaced apart from an adjacent flipper on each said of said longitudinally extending members such that when said longitudinally extending members are in a first orientation, said flippers extend substantially horizontally from said parallel rails and when said longitudinally extending members are in a second orientation, said flippers extend substantially vertically from said parallel rails, means to move said longitudinally extending members between said first and second orientations wherein said longitudinally extending members are biased to cause said flippers to assume said first orientation.

2. The device of claim 1 wherein diverters are appended to a second end of said forks.

3. The device of claim 2 wherein said diverters are angled from said parallel rails.

4. The device of claim 2 wherein said diverters are pivotable both horizontally and vertically from the ends of said forks.

5. The device of claim 1 wherein each flipper is spaced a distance from its adjacent flipper a length selected to approximately be the size of a lip of a pot.

6. The device of claim 5 wherein substantially horizontally extending plates are appended to said rails between said flippers.

7. The device of claim 6 wherein said longitudinally extending members are selectively channeled within sleeves along said parallel rails, said flippers being appended to said longitudinally extending members and said substantially horizontally extending plates being appended to said sleeves.

8. The device of claim 1 wherein said continuous drive is affixed to a fork proximate an extremity of said horizontally extending member and is pulled toward said extremity upon actuation of said reversible motor in a first direction along said horizontally extending member causing said forks to separate from one another.

9. The device of claim 1 wherein said continuous drive is affixed to a fork proximate an extremity of said horizontally extending member and is pulled toward said extremity upon actuation of said reversible motor in a first direction wherein linkages are affixed between forks such that as forks move away from one another, said linkages move said forks along said horizontally extending member causing said forks to separate from one another.

10. The device of claim 9 wherein said linkages are provided with adjustable stops to allow for adjustment of the separation between forks as said forks are caused to separate from one another.

11. The device of claim 8 wherein said reversible motor in being actuated in a second direction causes said fork proximate the extremity of said horizontally extending member to move away from said extremity and towards an adjacent fork.

12. The device of claim 11 wherein as said reversible motor is being actuated in said second direction, all of said forks are caused to move closer to one another.

13. The device of claim 1 wherein said rails are spaced such that as said longitudinally extending members are in their second orientation and said forks are raised vertically by actuation of said forklift, a first series of pots situated between opposing flippers remain at ground level while a second series of pots situated between opposing substantially horizontally extending plates are raised above the ground.

14. The device of claim 13 further comprising means for raising said second series of pots a distance above said first series of pots to enable said second series of pots to be moved from their proximity to said first series of pots.

15. The device of claim 1 wherein controls are provided proximate the seating area of said moving vehicle to enable said operator to control said device during operation of said vehicle.

16. A method of increasing spacing of pots arranged in an array of columns comprising operating a vehicle having appended thereto the device of claim 1, aligning said pots within said forks of said device such that said columns are positioned between said pairs of parallel rails, moving said device to capture said pots between said parallel rails, actuating said reversible motor and moving said continuous drive to separate said forks from one another, rotating said longitudinally extending members from their first to their second orientations, elevating said device a sufficient height such that a first series of pots between flippers remain at ground level and a second series not between flippers are elevated above said first series, moving said vehicle away from said array to displace said second series of pots away from said first series of pots.

17. The method of claim 16 wherein once said vehicle is moved away from said array, said forks are lowered and said second series of pots placed at ground level.

18. The method of claim 16 wherein diverters, appended to a second end of said forks are introduced to and between said columns such that as said forks move toward said columns, said diverters urge said pots between said rails.

19. The device of claim 1 wherein said continuous drive comprises a chain drive.

20. The device of 1 wherein longitudinally extending members comprise rods.

21. The device of claim 1 wherein said reversible motor comprises a hydraulic motor.
